(19) United States
(12) Patent Application Publication
(10) Pub. No.: US 2013/0017385 A1
(43) Pub. Date: Jan. 17, 2013

(54) PACKING OF PREPREG ROLLS

(71) Applicants: Irene LOZOYA-LOPEZ, Albacete (ES); Monica FERNANDEZ-GARCIA, Albacete (ES); Jose Maria MUNOZ-ESPIGARES, Albacete (ES); Emilio Esteban-Franceschi, Valencia (ES)

(72) Inventors: Irene LOZOYA-LOPEZ, Albacete (ES); Monica FERNANDEZ-GARCIA, Albacete (ES); Jose Maria MUNOZ-ESPIGARES, Albacete (ES); Emilio Esteban-Franceschi, Valencia (ES)

(73) Assignee: Gurit (UK) Ltd., Newport (GB)

(21) Appl. No.: 13/181,706

(22) Filed: Jul. 13, 2011

(51) Int. Cl. B32B 3/00; B65B 1/04

(52) U.S. Cl. 428/220; 53/235

(57) ABSTRACT

A packing system for a plurality of prepreg rolls, the packing system comprising a plurality of prepreg rolls on a pallet, wherein each prepreg roll comprises a helical winding of prepreg material co-axially mounted around a central cylindrical tube, the prepreg material having opposite side faces, the central cylindrical tube having opposite ends which are each spaced outwardly from a respective side face, the prepreg rolls being stacked on the pallet in a horizontal orientation, with the roll axes being vertically oriented and the side faces being horizontally oriented, the rolls forming at least two layers of vertically stacked prepreg rolls, and at least one rigid separation layer, each rigid separation layer separating adjacent prepreg roll layers, the ends of the central cylindrical tubes contacting the pallet and the rigid separation layers to form a structural assembly of alternating central cylindrical tubes and rigid separation layers which supports the entire weight of the plurality of prepreg rolls on the pallet, both an upper surface of the pallet and surfaces of the at least one rigid separation layer being spaced from a respective opposed side face of an adjacent helical winding of prepreg material.

### FIELD OF THE INVENTION

The present invention relates to a prepreg, in roll form, for manufacturing a fibre-reinforced resin composite material, the prepreg roll having improved packing capability and a packing system for such prepreg rolls.

### BACKGROUND

It is well known to produce prepregs for manufacturing a fibre-reinforced resin composite material. The prepreg material is typically supplied in the form of a roll. The prepreg material comprises structural fibres, typically composed of carbon or glass, together with a resin material, typically a thermosetting resin such as an epoxy resin. In some prepregs, the resin material fully impregnates the structural fibres. In other prepregs, the resin material either only partially impregnates the structural fibres or is adhered to the fibres without any substantial impregnation.

EP-A-1128958 discloses a prepreg having a three-layer sandwich structure comprising two outer layers of structural fibres and a central resin layer. The Assignee has manufactured and sold such a product in roll form for many years. The prepreg roll is temporarily wound up on a central cylindrical tube, for example of cardboard. In use, the tube is mounted for rotation on a shaft, and the prepreg material is progressively unwound from the roll.

When the prepreg is required to manufacture large structural elements composed of fibre-reinforced resin composite material, such as parts of wind turbine blades, the prepreg material on the roll is required to have significant width, typically at least 250 mm, so as to minimise the frequency of overlaps after layup of the prepreg material, and significant length, typically at least 100 m, so as to minimise the frequency of splicing of successive prepreg rolls during layup of the prepreg material. A typical prepreg roll for such an application weighs at least 50 kg, and typically at least 70 kg.

In order to minimise material deformation or damage prior to layup of the prepreg material, the rolls are shipped and stored on a pallet in the configuration shown in FIGS. 1 and 2.

The prepreg rolls 2 are stacked on the pallet 4 in a horizontal orientation, i.e. with the roll axis X-X being vertically oriented and the opposed sides 6, 8 of the roll 2 being horizontally oriented. In the illustrated arrangement, there are five layers 10, 12, 14, 16, 18 of prepreg rolls 2, with each layer 10, 12, 14, 16, 18 including a respective pair of adjacent prepreg rolls 2. The first layer 10 is disposed on the upper surface 20 of the pallet 4. A carton separation layer 22 of cardboard covers the first layer 10. The separation layer 22 is a continuous sheet which prevents any mutual contact between the vertically stacked sheet prepreg rolls 2. A second layer 12 is disposed on the upper surface 24 of the carton separation layer 22. The additional carton layers 22 and prepreg roll layers 14, 16, 18 are stacked in alternation to form the five layer tiered stack 26 with adjacent layers being separated by a respective carton separation layer 22. The carton separation layer 22 tends to flex under the applied load of the prepreg rolls 2, particularly in the lower portion of the stack 26.

In order to aim to distribute the weight evenly over the pallet 4 and over the stacked rolls 2, the central cylindrical tube 28 of each roll has a length which is substantially the same as, or less than, the width of the respective roll 2. This provides that substantially the entire lower surface of each roll 2 bears downwardly against either the upper surface 20 of the pallet 4 or the upper surface 24 of a carton separation layer 22. Equally, this provides that the entire upper surface 6 of each roll 2, apart from those rolls 2 of the top layer 18, bears upwardly against the lower surface 30 of a carton separation layer 22.

The provision of this whole surface contact of the sides of the prepreg rolls 2 is intended to maximize the load-bearing surface area of contact to reduce the stacking pressure in order to minimise prepreg damage. In the illustrated embodiment, the load on the lowermost roll of the stack is four times the weight of each roll, which may be more that 200 kg, or even more than 275 kg. The whole surface contact distributed by the carton separation layers and the sides of the rolls distribute the load over a maximized surface area, with an aim to minimise pressure on the lower rolls. The whole surface contact also tends to provide a stable stack which exhibits minimal, or typically zero, inadvertent roll movement or slippage during shipping.

However, it has recently been found that for some prepreg constructions employing the three-layer sandwich structure described above, such a packing structure suffers from the problem that at least the lower rolls of the stack tend to exhibit separation of one or both of the two outer layers of structural fibres from the central resin layer. The unimpregnated fibres can be pulled away from resin layer under the application of longitudinal tension to the prepreg material during unwinding from the roll. This is a significant technical problem, because such prepreg separation prevents consistent, even and reliable layup of the prepreg layers during the manufacture of a fibre-reinforced resin composite material.

A particular prepreg construction typically likely to suffer from such a separation problem is a biaxial prepreg, comprising two fibre layers each comprising a unidirectional fabric with the structural fibres respectively oriented (for example at +45° or −45°) to the longitudinal warp direction of the prepreg material, and with the outer surfaces of the fibre layers being backerless, i.e. not coated temporarily by a release liner material, such as a polyethylene film, which protects the fibre surface prior to use. It has been found that prepregs having such a release liner material tend not to suffer from the separation problem, whereas providing a backerless structure, particularly for a biaxial prepreg, tends to increase the incidence of the separation problem.

### SUMMARY OF THE INVENTION

The present invention aims at least partially to overcome at least some of these problems of the known prepreg packing system.

Accordingly, the present invention provides a packing system for a plurality of prepreg rolls, the packing system comprising a plurality of prepreg rolls on a pallet, wherein each prepreg roll comprises a helical winding of prepreg material co-axially mounted around a central cylindrical tube, the prepreg material having opposite side faces, the central cylindrical tube having opposite ends which are each spaced outwardly from a respective side face, the prepreg rolls being stacked on the pallet in a horizontal orientation, with the roll axes being vertically oriented and the side faces being horizontally oriented, the rolls forming at least two layers of vertically stacked prepreg rolls, and at least one rigid separation layer, each rigid separation layer separating adjacent prepreg roll layers, the ends of the central cylindrical tubes contacting the pallet and the rigid separation layers to form a structural assembly of alternating central cylindrical tubes and rigid separation layers which supports the entire weight of the plurality of prepreg rolls on the pallet, both an upper surface of the pallet and surfaces of the at least one rigid separation layer being spaced from a respective opposed side face of an adjacent helical winding of prepreg material.

Optionally, in any embodiment of the packing system of the present invention the prepreg material has a sandwich structure comprising two layers of structural fibres on opposite sides of a central resin layer. Typically, the prepreg material has a three-layer sandwich structure and the outer layers of structural fibres are partly impregnated by the central resin layer or bonded by resin adhesion to the surfaces of the central resin layer. Preferably, the prepreg material comprises a biaxial prepreg comprising two fibre layers, each fibre layer comprising a unidirectional fabric with the structural fibres respectively oppositely oriented to the longitudinal warp direction of the prepreg material.

Optionally, in any embodiment of the packing system of the present invention outer surfaces of the fibre layers are backerless and adjacent layers of the prepreg material in the winding are in direct mutual contact.

Optionally, in any embodiment of the packing system of the present invention the packing system comprises at least two adjacent tiers of prepreg rolls, with the rolls of each tier being mutually coaxial.

Optionally, in any embodiment of the packing system of the present invention the rigid separation layer is composed of wood, woodchip, plywood or particle board. Typically, the rigid layer is substantially rigid and does not substantially flex under the applied load of the prepreg rolls.

Optionally, in any embodiment of the packing system of the present invention the upper surface of the pallet and surfaces of the at least one rigid separation layer are spaced from a respective opposed side face of an adjacent helical winding of prepreg material by a distance of at least 0.5 mm.

Optionally, in one embodiment of the packing system of the present invention the ends of the cylindrical tube are equally spaced outwardly from the respective side face, and the ends extend a distance of from 0.5 mm to 7.5 mm outwardly away from the respective side face. Alternatively, in another embodiment of the packing system of the present invention the ends of the cylindrical tube are differently spaced from the respective side face, with one end extending a relatively large distance of from 7.5 mm to 14.5 mm away from the respective side face and the other end extending a relatively small distance of from 0.5 mm to 7.5 mm, away from the respective side face.

Optionally, in any embodiment of the packing system of the present invention the central cylindrical tube is composed of a high density cardboard, optionally having a Flat Crush Strength of at least 788 N/100 mm, a Radial Crush Strength of at least 9.7 bars, an Internal Diameter (ID) Stiffness of at least 0.83 bars/0.1 mm, and an Outer Diameter (OD) Stiffness of at least 0.73 bars/0.1 mm.

Optionally, in any embodiment of the packing system of the present invention the central cylindrical tube has an outer diameter of from 300 to 350 mm, optionally 322+/−1 mm, and a thickness of from 7.5 to 12.5 mm, optionally 9.7 to 10.3 mm.

The present invention further provides a prepreg roll comprising a helical winding of prepreg material co-axially mounted around a central cylindrical tube, the prepreg material having opposite side faces, the prepreg material having a sandwich structure comprising two layers of structural fibres on opposite sides of a central resin layer, the central cylindrical tube having opposite ends which are each spaced from a respective side face by a distance of at least 0.5 mm.

Optionally, in any embodiment of the prepreg of the present invention the length of the central cylindrical tube is at least 1 mm greater than the width of the prepreg material. Typically, the length of the central cylindrical tube is from 10 mm to 20 mm greater than the width of the prepreg material, typically 15 mm longer. For example, for a nominal 240 mm width of the prepreg material (which may be within a specification of 235 to 245 mm), the length of the central cylindrical tube may be 255 mm.

Optionally, in one embodiment of the prepreg of the present invention the ends of the cylindrical tube are equally spaced outwardly from the respective side face, and the ends extend a distance of from 0.5 mm to 7.5 mm outwardly away from the respective side face. In another embodiment, the ends of the cylindrical tube are differently spaced from the respective side face, with one end extending a relatively large distance of from 7.5 mm to 14.5 mm away from the respective side face and the other end extending a relatively small distance of from 0.5 mm to 7.5 mm, away from the respective side face.

Optionally, in any embodiment of the prepreg of the present invention the prepreg material has a three-layer sandwich structure and the outer layers of structural fibres are partly impregnated by the central resin layer or bonded by resin adhesion to the surfaces of the central resin layer. Typically, the prepreg material comprises a biaxial prepreg comprising two fibre layers, each fibre layer comprising a unidirectional fabric with the structural fibres respectively oppositely oriented to the longitudinal warp direction of the prepreg material.

Optionally, in any embodiment of the prepreg of the present invention outer surfaces of the fibre layers are backerless and adjacent layers of the prepreg material in the winding are in direct mutual contact.

### BRIEF DESCRIPTION OF THE DRAWINGS

Embodiments of the present invention will now be described, by way of example only, with reference to the accompanying drawings, in which:

FIG. 1 is a plan view of a known prepreg roll incorporating a central cylindrical tube;

FIG. 2 is a side view showing a pallet stacked with a plurality of the prepregs of FIG. 1 in a known prepreg packing system;

FIG. 3 is a plan view of a prepreg roll, partly unwound, incorporating a central cylindrical tube in accordance with an embodiment of the present invention;

FIG. 4 is a side view of the prepreg roll of FIG. 3; and

FIG. 5 is a side view showing a pallet stacked with a plurality of the prepregs of FIG. 3 in a prepreg packing system in accordance with an embodiment of the present invention.

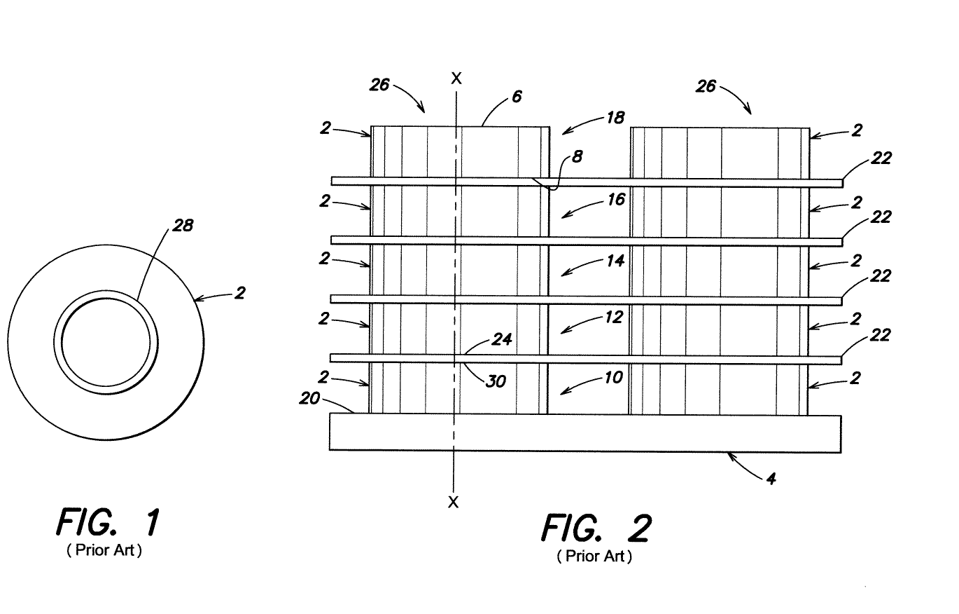

### DETAILED DESCRIPTION

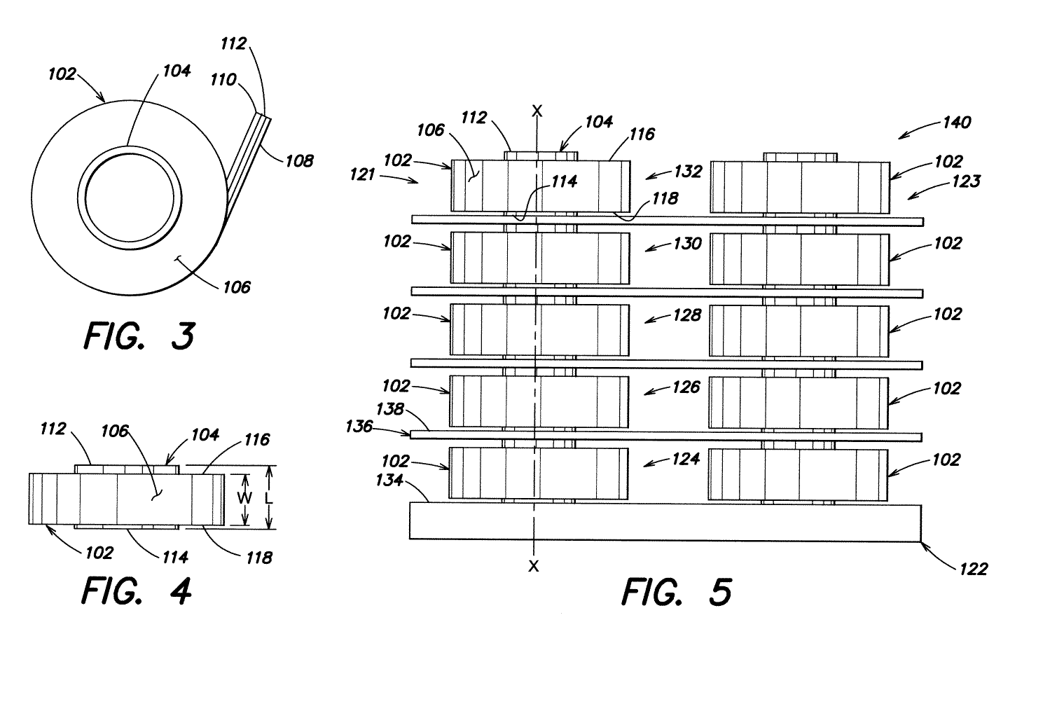

Referring to FIGS. 3, 4 and 5, a prepreg roll 102 co-axially mounted around a central cylindrical tube 104 in accordance with an embodiment of the present invention is illustrated. The prepreg roll 102 includes a helical winding of prepreg material 106. The prepreg material 106 of the roll 102 typically has a width of at least 240 mm and a length of at least 290 m. The prepreg roll 102 typically weighs at least 50 kg, and more typically at least 65 kg.

The prepreg material 106 has a three-layer sandwich structure comprising two outer layers 108, 110 of structural fibres on opposite sides of a central resin layer 112 (these layers are shown enlarged in thickness in FIG. 3 for the purpose of clarity of illustration only). The outer layers 108, 110 of structural fibres may be partly impregnated by the central resin layer 112, or alternatively the outer layers 108, 110 of structural fibres may be bonded, by resin adhesion, to the surfaces of the central resin layer 112. The prepreg outer surfaces are therefore composed of dry fibres.

The prepreg material 106 of the illustrated embodiment comprises a biaxial prepreg, comprising two fibre layers 108, 110 each comprising a unidirectional fabric with the structural fibres respectively oriented at +45° and −45° to the longitudinal warp direction of the prepreg material 106. Other fibre orientations may be employed, such as +60° and −60° to the longitudinal warp direction.

The outer surfaces of the fibre layers 108, 110 are backerless, i.e. not coated temporarily by a release liner material, such as a polyethylene film, which protects the fibre surface prior to use. Accordingly, adjacent layers of the helically wound prepreg material 106 in the winding of the roll 102 are in direct mutual contact.

The central cylindrical tube 104 has a length L, for example 255 mm, which is significantly greater, for example at least 10 mm greater, more typically from 10 mm to 15 mm greater, than the nominal width W, for example 240 mm, of the prepreg material 106.

The ends 112, 114 may each independently extend a respective distance of for example at least 0.5 mm, more typically from 0.5 to 25 mm, still more typically from 2.5 to 15 mm, yet more typically from 5 to 10 mm, even more typically about 7.5 mm, away from the respective side face 116, 118.

In one typical construction, the ends 112, 114 of the cylindrical tube 104 may be equally spaced from the respective side face 116, 118 of the roll 102, and the ends 112, 114 may extend a distance of for example at least 0.5 mm, more typically from 0.5 to 25 mm, still more typically from 2.5 to 15 mm, yet more typically from 5 to 10 mm, even more typically about 7.5 mm, away from the respective side face 116, 118.

In another typical construction, the ends 112, 114 of the cylindrical tube 104 may be differently spaced from the respective side face 116, 118 of the roll 102. One end 112 may extend a relatively large distance of, for example, at least 0.5 mm, more typically from 0.5 to 25 mm, still more typically from 2.5 to 20 mm, yet more typically from 5 to 15 mm, even more typically from 7.5 to 15 mm, away from the respective side face 116 and the other end 114 may extend a relatively small distance of, for example, at least 0.5 mm, more typically from 0.5 to 20 mm, still more typically from 0.5 to 15 mm, yet more typically from 0.5 to 10 mm, even more typically from 0.5 to 7.5 mm, away from the respective side face 118.

The central cylindrical tube 104 is composed of a rigid material, which does not deform or collapse under loads typically applied when the rolls are stacked as described hereinafter. Typically, the central cylindrical tube 104 is composed of a high density cardboard, for example having a Flat Crush Strength of at least 788 N/100 mm, a Radial Crush Strength of at least 9.7 bars, an Internal Diameter (ID) Stiffness of at least 0.83 bars/0.1 mm, and an Outer Diameter (OD) Stiffness of at least 0.73 bars/0.1 mm.

Typically, the central cylindrical tube 104 has an outer diameter of from 300 to 350 mm, optionally 322+/−1 mm, and a thickness of from 7.5 to 12.5 mm, optionally 9.7 to 10.3 mm.

Referring to FIG. 5, a packing system, designated generally as 120, in accordance with an embodiment of the present invention is illustrated.

In order solve the problem of layer separation upon unwinding of the prepreg material 106 from the roll 102 under tension, and also to minimise material deformation or damage prior to layup of the prepreg material, the rolls 102 of FIGS. 3 and 4 are shipped and stored on a pallet 122 in the configuration shown in FIG. 5.

The prepreg rolls 102 are stacked on the pallet 122 in a horizontal orientation, i.e. with the roll axis X-X being vertically oriented and the opposed side face 116, 118 of the roll 102 being horizontally oriented. In the illustrated arrangement, there are five layers 124, 126 128, 130, 132 of prepreg rolls 102, with each layer 124, 126 128, 130, 132 including a respective pair of adjacent prepreg rolls 102. The rolls 102 form two adjacent tiers 121, 123 of five rolls 102, with the rolls 102 of each tier 121, 123 being mutually coaxial. The first layer 124 is disposed on the upper surface 134 of the pallet 122.

A rigid separation layer 136 covers the first layer 124. A second layer 126 is disposed on the upper surface 138 of the rigid separation layer 136. The additional rigid separation layers 136 and prepreg roll layers 128, 130, 132 are stacked in alternation to form the five layer stack 140 with adjacent prepreg roll layers 124, 126 128, 130, 132 being separated by a respective rigid separation layer 136.

The rigid separation layer 136 is typically composed of wood, woodchip, plywood, particle board, or the like. The rigid layer 136 has mechanical properties so that it is substantially rigid, and does not substantially flex, under the applied load of the prepreg rolls 102, particularly in the lower portion of the stack 140.

The outwardly extending ends 112, 114 of the cylindrical tube 104 are respectively located above and below the respective roll 102. The ends 112, 114 engage the adjacent surface of the rigid layer 136 or pallet 122. This provides that substantially none of the lower side faces 118 of the rolls 102 bear downwardly against either the upper surface of the pallet 122 or the upper surface of a rigid layer 136. Equally, this provides that substantially none of the upper side faces 116 of the rolls 102 bear upwardly against the lower surface of a rigid layer 136. Instead, the entire load of the rolls 102 on the pallet 12 is carried by the alternating sequential stack of cylindrical tubes 104 and rigid layers 136.

The substantial avoidance of any surface contact of the side faces 116, 118 of the prepreg rolls 102 with the rigid separation layers 136 or the pallet 122 avoids applying any potential deformation load to the prepreg material 106, which reduces, avoids or minimizes prepreg damage. This in turn has been found to overcome the problem of inadvertent material separation, as discussed above, when the prepreg roll 102 is unwound under tension.

The stacking of the prepreg rolls 102 with the engaging of the cylindrical tubes 104 and rigid separation layers 136 has also been found to provide a stable stack which exhibits minimal, or typically zero, inadvertent roll movement or slippage during shipping.

In particular, it has been found that for the preferred prepreg construction employing a three-layer sandwich structure and comprising a biaxial prepreg, comprising two fibre layers each comprising a unidirectional fabric with the structural fibres respectively oriented at opposite directions to the longitudinal warp direction of the prepreg material, and with the outer surfaces of the fibre layers being backerless, such a prepreg structure does not tend to suffer from the problem of at least the lower rolls of the stack exhibiting material separation of one or both of the two outer layers of structural fibres from the central resin layer, such separation being manifested in the unimpregnated fibres being pulled away from resin layer under the application of longitudinal tension to the prepreg material during unwinding from the roll.

This technical problem of prepreg separation has been overcome, which enables consistent, even and reliable layup of the prepreg layers during the manufacture of a fibre-reinforced resin composite material.

In alternative embodiments, the prepreg may have different fibre orientations than a biaxial prepreg as for the illustrated embodiment, for example may be unidirectional or triaxial. The fibres may be composed of any suitable material, most typically carbon or glass. The resin may be any suitable thermosetting resin, such as an epoxy resin, or alternatively may comprise a thermoplastic resin. Various fibre weights and tex values may be employed, as well as various fractions of the resin weight relative to the fibre weight.

Other modifications to the prepreg roll and the packing system of the preferred embodiments of the present invention will be readily apparent to those skilled in the art.

What is claimed is:

1. A packing system for a plurality of prepreg rolls, the packing system comprising a plurality of prepreg rolls on a pallet, wherein each prepreg roll comprises a helical winding of prepreg material co-axially mounted around a central cylindrical tube, the prepreg material having opposite side faces, the central cylindrical tube having opposite ends which are each spaced outwardly from a respective side face, the prepreg rolls being stacked on the pallet in a horizontal orientation, with the roll axes being vertically oriented and the side faces being horizontally oriented, the rolls forming at least two layers of vertically stacked prepreg rolls, and at least one rigid separation layer, each rigid separation layer separating adjacent prepreg roll layers, the ends of the central cylindrical tubes contacting the pallet and the rigid separation layers to form a structural assembly of alternating central cylindrical tubes and rigid separation layers which supports the entire weight of the plurality of prepreg rolls on the pallet, both an upper surface of the pallet and surfaces of the at least one rigid separation layer being spaced from a respective opposed side face of an adjacent helical winding of prepreg material.

2. A packing system according to claim 1 wherein the prepreg material has a sandwich structure comprising two layers of structural fibres on opposite sides of a central resin layer.

3. A packing system according to claim 2 wherein the prepreg material has a three-layer sandwich structure and the outer layers of structural fibres are partly impregnated by the central resin layer or bonded by resin adhesion to the surfaces of the central resin layer.

4. A packing system according to claim 1 wherein the prepreg material comprises a biaxial prepreg comprising two fibre layers, each fibre layer comprising a unidirectional fabric with the structural fibres respectively oppositely oriented to the longitudinal warp direction of the prepreg material.

5. A packing system according to claim 1 wherein outer surfaces of the fibre layers are backerless and adjacent layers of the prepreg material in the winding are in direct mutual contact.

6. A packing system according to claim 1 comprising at least two adjacent tiers of prepreg rolls, with the rolls of each tier being mutually coaxial.

7. A packing system according to claim 1 wherein the rigid separation layer is composed of wood, woodchip, plywood or particle board.

8. A packing system according to claim 1 wherein the rigid layer is substantially rigid and does not substantially flex under the applied load of the prepreg rolls.

9. A packing system according to claim 1 wherein the upper surface of the pallet and surfaces of the at least one rigid separation layer are spaced from a respective opposed side face of an adjacent helical winding of prepreg material by a distance of at least 0.5 mm.

10. A packing system according to claim 9 wherein the ends of the cylindrical tube are equally spaced outwardly from the respective side face, and the ends extend a distance of from 0.5 to 7.5 mm outwardly away from the respective side face.

11. A packing system according to claim 9 wherein the ends of the cylindrical tube are differently spaced from the respective side face, with one end extending a relatively large distance of from 7.5 to 14.5 mm away from the respective side face and the other end extending a relatively small distance of from 0.5 to 7.5 mm away from the respective side face.

12. A packing system according to claim 1 wherein the central cylindrical tube is composed of a high density cardboard, optionally having a Flat Crush Strength of at least 788 N/100 mm, a Radial Crush Strength of at least 9.7 bars, an Internal Diameter (ID) Stiffness of at least 0.83 bars/0.1 mm, and an Outer Diameter (OD) Stiffness of at least 0.73 bars/0.1 mm.

13. A packing system according to claim 1 wherein the central cylindrical tube has an outer diameter of from 300 to 350 mm, optionally 322+/−1 mm, and a thickness of from 7.5 to 12.5 mm, optionally 9.7 to 10.3 mm.

14. A prepreg roll comprising a helical winding of prepreg material co-axially mounted around a central cylindrical tube, the prepreg material having opposite side faces, the prepreg material having a sandwich structure comprising two layers of structural fibres on opposite sides of a central resin layer, the central cylindrical tube having opposite ends which are each spaced from a respective side face by a distance of at least 0.5 mm.

15. A prepreg roll according to claim 14 wherein the length of the central cylindrical tube is at least 1 mm greater than the width of the prepreg material.

16. A prepreg roll according to claim 15 wherein the length of the central cylindrical tube is from 1 to 15 mm greater than the width of the prepreg material.

17. A prepreg roll according to claim 14 wherein the ends of the cylindrical tube are equally spaced outwardly from the respective side face, and the ends extend a distance of from 0.5 to 7.5 mm outwardly away from the respective side face.

18. A prepreg roll according to claim 14 wherein the ends of the cylindrical tube are differently spaced from the respective side face, with one end extending a relatively large distance of from 7.5 to 14.5 mm away from the respective side face and the other end extending a relatively small distance of from 0.5 to 7.5 mm, away from the respective side face.

19. A prepreg roll according to claim 14 wherein the central cylindrical tube is composed of a high density cardboard, optionally having a Flat Crush Strength of at least 788 N/100 mm, a Radial Crush Strength of at least 9.7 bars, an Internal Diameter (ID) Stiffness of at least 0.83 bars/0.1 mm, and an Outer Diameter (OD) Stiffness of at least 0.73 bars/0.1 mm.

20. A prepreg roll according to claim 19 wherein the central cylindrical tube has an outer diameter of from 300 to 350 mm, optionally 322+/−1 mm, and a thickness of from 7.5 to 12.5 mm, optionally 9.7 to 10.3 mm

21. A prepreg roll according to claim 14 wherein the prepreg material has a three-layer sandwich structure and the outer layers of structural fibres are partly impregnated by the central resin layer or bonded by resin adhesion to the surfaces of the central resin layer.

22. A prepreg roll according to claim 14 wherein the prepreg material comprises a biaxial prepreg comprising two fibre layers, each fibre layer comprising a unidirectional fabric with the structural fibres respectively oppositely oriented to the longitudinal warp direction of the prepreg material.

23. A prepreg roll according to claim 14 wherein outer surfaces of the fibre layers are backerless and adjacent layers of the prepreg material in the winding are in direct mutual contact.
